(19) United States
(12) Patent Application Publication
(10) Pub. No.: US 2003/0124042 A1
(43) Pub. Date: Jul. 3, 2003

(54) Method for separating each substance from mixed gas containing plural substances and apparatus thereof

(75) Inventors: Miwa Nakazawa, Kanagawa (JP); Kinya Kato, Kanagawa (JP); Teruyuki Endo, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/320,434

(22) Filed: Dec. 17, 2002

(30) Foreign Application Priority Data
Dec. 28, 2001 (JP) 400299/2001
May 9, 2002 (JP) 134100/2002
Dec. 10, 2002 (JP) 358067/2002

(51) Int. Cl. B01D 53/68

(52) U.S. Cl. 423/240 R; 423/241

(57) ABSTRACT

The present invention provides a method for separating each substance from a mixed gas containing a plurality of substances comprising the steps of: liquefying the mixed gas by cooling; and separating the plural substances transferred into a liquid generated by the liquefying step into the substances of one group and the substances of the other group, wherein the substances of one group substantially remain to present in the liquid and the substances of the other group are separated from the liquid by evaporation.

### BACKGROUND OF THE INVENTION

1. Field of the Invention

The present invention relates to a method for separating each substance from a mixed gas containing a plurality of substances, and an apparatus used for the method.

2. Description of the Related Art

A vast quantity of organic chlorine compounds (for example chlorinated ethylene, chlorinated methane and the like) have been consumed with recent advance of industrial technologies, and disposal of these materials have became serious problems. Wastes from these substances have arose problems of environmental pollution, and much effort have been paid for solving the problems.

Photolysis methods by irradiation of UV light in a gas phase have been attempted as practical methods for disposal of decomposition objects retrieved from polluted soil and groundwater, in particular halogenated aliphatic hydrocarbon compounds. A method proposed includes irradiating waste gases containing organic halogen compounds with UV light to decompose into acidic decomposition gases, and rendering the decomposed gases harmless by washing with an alkali (Japanese Unexamined Patent Application Publication No. 62-191025). Also proposed is an apparatus for aerating waste water containing organic halogen compounds to the air, and washing the exhaust gases with an alkali after UV irradiation (Japanese Unexamined Patent Application Publication No. 62-191095).

In a different photolysis method, a decomposition apparatus of gaseous halogenated aliphatic hydrocarbon compounds is proposed, by which chlorine gas and gaseous halogenated aliphatic hydrocarbon compounds to be decomposed are mixed together, and the mixed gas is irradiated with UV light (EP 1010453A1). This decomposition apparatus takes advantage of chlorine gas generated from a solution containing chlorine as a simple and safe means for obtaining a gas containing chlorine gas.

Another method and apparatus for clarifying polluted soil have been proposed (Japanese Unexamined Patent Application Publication No. 2001-058177). The polluted soil is dispose in a predetermined clarifying vessel, and functional water is fed into the clarifying vessel. The polluted soil makes contact with functional water in the vessel, the mixture of the polluted soil and functional water is stirred, and pollutants in the soil start to dissolve into functional water. The pollutants dissolved in functional water are decomposed by decomposition ability of functional water when a light is irradiated to the mixture of polluted soil and functional water. The pollutants in the soil further dissolves into functional water as the concentration of the pollutants in functional water decreases, the dissolved pollutants are sequentially decomposed, and the pollutants are finally removed from the polluted oil with decomposition to achieve complete clarification of the polluted soil.

Functional water is referred to as a solution containing hypochlorous acid with low pH, and the solution available shows a hydrogen ion concentration (pH) of 1 to 4 and chlorine concentration of 5 to 150 mg/l. Such solution may be prepared, for example, by dissolving hypochlorous acid salts (such as sodium or potassium hypochlorite) and inorganic acids in water.

A solution formed in the vicinity of a positive electrode by electrolysis of water containing electrolytes is also called functional water, and is used for decomposition of the pollutants.

### SUMMARY OF THE INVENTION

Although various apparatus and methods for clarifying the polluted soil, and decomposition apparatus and methods of decomposition objects have been proposed, sufficient treatments of the decomposition products have not been applied in most of these proposals. Accordingly, the inventors of the present invention have noticed that it is preferable to apply additional separation or decomposition process to the decomposition products.

The present invention provides a method for separating each substance from mixed gases containing a plurality of substances, and an apparatus to be used for the method.

In particular, the present invention provides a method for advanced separation or decomposition by separating decomposition products containing a plurality of substances obtained by decomposition of decomposition objects, and an apparatus to be used for the method.

The present invention provides a method for separating each substance from a mixed gas containing a plurality of substances comprising the steps of: liquefying the mixed gas by cooling; and separating the plural substances transferred into a liquid generated by the liquefying step into the substances of one group and the substances of the other group, wherein the substances of one group substantially remain to present in the liquid and the substances of the other group are separated from the liquid by evaporation.

The present invention also provides an apparatus for separating each substance from a mixed gas containing a plurality of substances comprising: cooling means for liquefying the mixed gas by cooling; and separation devices for separating the plural substances transferred into a liquid generated by the liquefying device into the substances of one group and the substances of the other group, wherein the substances of one group substantially remain to present in the liquid and the substances of the other group are separated from the liquid by evaporation.

The present invention also comprises a decomposition step of decomposition objects that exists as a gas after decomposition, and a liquefying step for liquefying decomposition products generated in the decomposition step by cooling.

Chlorine can be removed from the liquid by adjusting the hydrogen ion concentration (pH value) in the liquid liquefied by pressurizing to 4 or less.

Further objects, features and advantages of the present invention will become apparent from the following description of the preferred embodiments (with reference to the attached drawings).

### BRIEF DESCRIPTION OF THE DRAWINGS

FIG. 1 illustrates a separation apparatus of substances according to one embodiment of the present invention.

FIG. 2 illustrates a separation apparatus of substances according to another embodiment of the present invention.

FIG. 3 illustrates a separation apparatus of substances according to a different embodiment of the present invention.

FIG. 4 illustrates a separation apparatus of substances according to a further different embodiment of the present invention.

FIG. 5 illustrates a separation apparatus of substances according to a further different embodiment of the present invention.

FIG. 6 illustrates a separation apparatus of substances according to a further different embodiment of the present invention.

### DESCRIPTION OF THE PREFERRED EMBODIMENTS

Preferable embodiments of the present invention will be described hereinafter with reference to attached drawings.

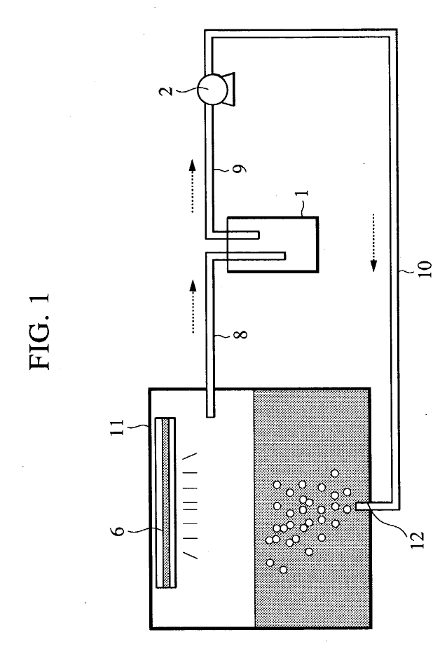

FIG. 1 shows a separation apparatus of substances according to one embodiment of the present invention.

The present invention provides a separation method of substances and an apparatus to be used for separation, wherein a mixed gas comprising a plurality of substances is liquefied by cooling. The plural substances transferred into a liquid generated by cooling are separated into the substances of one group and substances of the other group. The substances of one group substantially remain to exist in the liquid, while the substances of the other group is separated by evaporation from the liquid.

One embodiment of the separation apparatus according to the present invention is described hereinafter with reference to FIG. 1. The decomposition objects are decomposed by irradiating a light to a mixture of the decomposition objects and chlorine. The gas containing decomposition products after the decomposition treatment is continuously sent into a separation vessel 1 using a pump 2. Exhaust gases from the separation vessel 1 are controllable by means of a pump 3 at a discharge side, and the inside of the separation vessel 1 can be pressurized during the operation. Pressurized operation permits the decomposition products to be readily liquefied, and the liquefied products are pooled in the separation vessel 1. Most of the poled decomposition products are decomposed using decomposition electrodes 4a and 4b, and the decomposition objects converted into inorganic substances together with the decomposition products.

The reference numeral 5 denotes a photolysis reaction tank in which the decomposition object is decomposed by irradiating a light to the decomposition object in the presence of chlorine. The reference numeral 6 denotes a light irradiation device, and a gas containing the decomposition objects and a gas containing chlorine are sent into the reaction vessel 5 through a feed pipe 7.

Chlorine to be used for decomposition may be fed from a chlorine cylinder, or may be generated from a solution containing hypochlorous acid.

When chlorine generated from the solution containing hypochlorous acid is used, it is recommended to add a predetermined amount of an inorganic or organic acid to the solution containing hypochlorous acid, in order to permit chlorine to be efficiently generated. The hydrogen ion concentration (pH value) of the solution containing hypochlorous acid is preferably 4 or less, more preferably 1 to 4.

A gas containing chlorine may be more efficiently obtained by aerating the hypochlorous acid solution containing the acids as described above.

While representative embodiments for feeding chlorine was described above, any chlorine feed system may be used for treatment of by-products of the present invention, so long as the decomposition objects are decomposed by irradiating a light to a gas containing the decomposition objects in the presence of chlorine.

As shown in examples, the present invention is also applicable to a method comprising the steps of previously adding the decomposition objects into a hypochlorous acid solution containing an acid, or adding a hypochlorous acid solution containing an acid into a solution containing the decomposition objects; obtaining a mixture of a gas containing the decomposition objects and air containing chlorine by aeration of the solution; and decomposing the decomposition objects by irradiating a light to the mixture.

The decomposition products can be separated by liquefaction by pressurizing a gas obtained by irradiating a light to the mixture of the gas containing the decomposition objects and air containing chlorine. Consequently, the decomposition products are pooled as a concentrated solution in the separation vessel 1, and is able to be separated from a gas after clarification. The gas after separating the decomposition products are recycled as a gas for aerating the solution containing the decomposition products and the solution containing an acid and hypochlorous acid. While the decomposition products are liquefied in the separation vessel 1, the liquefied liquid in the separation vessel 1 is preferably acidified as shown in example 5. Acidifying as described above permits chlorine to be separated from the solution containing the decomposition products and hypochlorous acid. In particular, separated chlorine may be used for decomposition again by recycling the gas.

An inorganic or organic acid may be added for acidifying the content of the separation vessel.

The separated chlorine may be used for decomposition again particularly when the gas is recycled.

The present invention is applicable when the substances as the decomposition objects are either in a gas state or in a liquid state as described above.

For example, the present invention is applicable for disposal of the decomposition objects aspirated from the soil, clarification of polluted exhaust gases discharged from chemical process factories and disposal in gaseous states of polluted gases generated by aeration of polluted water, as well as disposal of polluted water in liquid states of polluted underwater and treatment of high concentration solvents desorbed from activated charcoal.

Although the decomposition objects available in the present invention are not particularly restricted, they are chlorinated ethylene chlorinated methane, for example. Examples of the chloro-substituted ethylene include mono- to tetra-chloride of ethylene such as monochloroethyelen, dichloroethylene (DCE), trichloroethylene (TCE) and tetrachloroethylene (PCE). Dichloroethylene includes, for example, 1,1-dichloroethylene (vinylidene chloride), cis-1,2-dichloroethylene and trans-1,2-dichloroethylene. Chlorinated methane includes chloro-substituents of methane such as monochloromethane, dichloromethane and trichloromethane.

A light irradiation device available in the present invention is able to emit a light with a wavelength that can permeate through a glass, for example a light with a wavelength of 300 to 500 nm or a light with a wavelength of 350 to 450 nm.

While the separation vessel 1 is disposed between two pumps in FIG. 1 in order to obtain a predetermined pressure in the construction for pressurizing the gas after the photolysis treatment, a material that gives a resistance may be placed at the downstream in order to give a positive pressure within the separation vessel 1. The resistance caused by the shape of piping may be utilized, for example, for this purpose. Otherwise, a device for absorbing the gas used for decomposition may be disposed at the downstream in order to utilize a differential pressure generated by the device.

The pressure range within the separation vessel is preferably 1.1 to 5 atm, more preferably 1.1 to 2 atm.

When the substance as the decomposition object is chlorinated ethylene, the major decomposition products thereof are chloroacetic acids such as trichloroacetic acid, dichloroacetic acid and monochloroacetic acid. Since chlorinated ethylene exists in a gaseous state in a photoreaction field, chloroacetic acids are present as a mist (gaseous sate) immediately after the decomposition reaction, or immediately after forming chloroacetic acids from chlorinated ethylene, although chloroacetic acid is a liquid at room temperature. Consequently, compression of the mist substances (gaseous substances) with a relatively small pressure is able to liquefy the decomposition products into a liquid state. The liquid liquefied by compression contains a plurality of substances, for example chloroacetic acids and chlorine as major decomposition products when the decomposition objects are chlorinated ethylene compounds. The liquid containing decomposition products comprising chloroacetic acids and chlorine gradually are acidified when chloroacetic acids as the decomposition products are continuously introduced thereto. Chlorine in the liquid is converted into chlorine gas due to the change of the hydrogen concentration (pH value) when the liquid is acidified, and is discharged from the liquid, thereby enabling the decomposition products to be separated from the gas after clarification. The hydrogen ion concentration (pH value) in the liquid is preferably 4 or less, more preferably 1 to 4, for discharging chlorine as a chlorine gas.

An inorganic or organic acid may be added for acidifying the liquid.

Alternatively, the products obtained by decomposition may be further decomposed by disposing positive and negative electrodes 4a and 4b for decomposition in the separation vessel 1. Most of the decomposition products are converted into inorganic substances by electrolysis by the action of the electrodes.

Electrode materials known in the art such as gold, silver, platinum, nickel, iron, copper and lead, an alloy thereof, and stainless steel may be used as the electrodes for electrolysis.

An electrolyte may be added in the solution comprising the decomposition products for electrolysis.

Although the voltage and the amount of current flow are not particularly restricted, it is recommended to decompose the decomposing object at high concentration since the amount of decomposition is proportional to the amount of electric power and the concentration of the decomposition objects.

### EXAMPLES

Examples of the present invention will be described in detail hereinafter.

### Example 1

(Polluted Gas Clarification System)

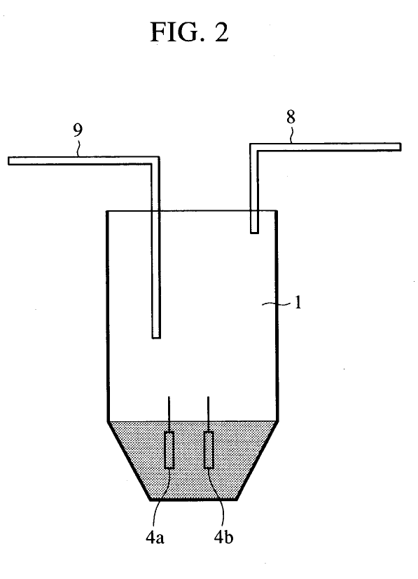

FIG. 2 shows an example of the construction of the separation apparatus of the substances according to the present invention. In this apparatus, a mixture of the decomposition objects and chlorine in a photolysis reaction tank 5 is irradiated with a light from a light irradiation device 6, and the decomposition objects are decomposed. The gas containing the decomposition products after the decomposition treatment is continuously sent into a separation vessel 1 using a pump 2. The exhaust gas from the separation vessel 1 passes through a chlorine separation tank 17 provided at the discharge side. While chlorine is absorbed into the solution in the chlorine separation tank 17, a resistance against the exhaust stream is generated in this process mainly by a hydraulic pressure of the solution. Consequently, the inside of the separation vessel 1 is pressurized. The decomposition products are readily liquefied by operating under a pressure, and the liquefied decomposition products are pooled in the separation vessel. Most of the decomposition products in the pool are further decomposed using decomposition electrodes 4a and 4b, and the decomposition objects as well as the decomposition products are converted into inorganic substances.

A mixed gas comprising 100 ppmv of Trichloroethylene and 50 ppmv of chlorine was fed from a feed pipe 7 into the photolysis reaction tank made of a glass, and the mixed gas was irradiated using a black light fluorescence lamp 5 (trade name FL10BLB made by Toshiba Corporation, a 10 W light source with a wavelength peak at near 360 nm). While the light is irradiated from the inside in FIG. 2, the light was actually irradiated from the outside of the photolysis reaction tank 5 using a fluorescence lamp emitting a black light.

The photolysis reaction tank has a net volume of about 50 liter, and the mixed gas was fed so that the residence time becomes one minute. The pump 2 (APN215 made by Iwaki Co.) was operated at 30 l/min.

The reference numeral 17 denotes a chlorine absorption tank for absorbing chlorine, which is willed at a liquid level of 0.7 m. The reference numeral 18 denotes an exhaust pipe.

The concentration of trichloroethylene was measured at the outlet of the piping 8 in order confirm decomposition of trichloroethylene in the photolysis reaction tank 5, obtaining a value of 0.05 ppmv or less.

The major photolysis product of trichloroethylene is dichloroacetic acid. For confirming the effect of the pump 2 and chlorine absorption tank 17 for separating dichloroacetic acid, an additional pump was placed between the chlorine absorption tank 17 and separation vessel 1, and the system was operated without pressurizing the inside of the separation vessel 1. The concentration of dichloroacetic acid at the outlet of the piping 8 with no pressurization was compared with the concentration of dichloroacetic acid at the outlet of the piping 8 when the inside of the separation vessel 1 is positively pressurized using the chlorine absorption tank 17, and found that 80% or more of dichloroacetic acid was separated in the separation vessel 1.

Then, in order to recognize decomposition ability of the separation vessel against the decomposition products, the concentration of dichloroacetic acid in the separation vessel 1 when electrolysis was applied using the electrodes in the separation vessel 1 was compared with the concentration of dichloroacetic acid when no electrolysis was applied.

Platinum electrode plates were used for electrolysis at a voltage of 14V with an electric current of 1 A. The separation vessel 1 with a volume of 500 ml is previously filled with 100 ml of 0.1% aqueous sodium chloride solution.

The polluted gas clarification system was operated for 24 hours in the examples with and without electrolysis. When the concentrations of dichloroacetic acid in the separation vessel 1 after 24 hours' operation were compared between the two examples, it was confirmed that 95% or more of the decomposition products trapped in the separation vessel per unit time was decomposed into inorganic substances at the electrodes in the separation vessel 1.

### Example 2

(Polluted Water Clarification System)

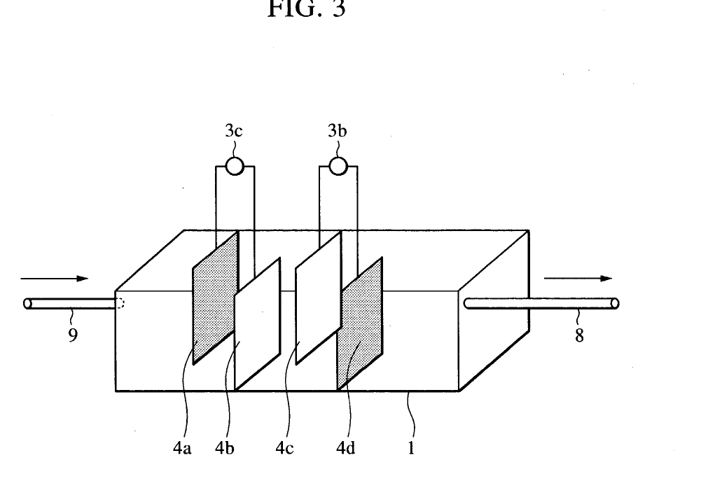

This example shows clarification of polluted water. In this system, a mixture such as a solution containing polluted water and hypochlorous acid is aerated, and aeration gas is recycled in a closed loop and irradiated with a light. A separation vessel for separation and decomposition of the decomposition products are provided in the closed loop, where the decomposition products are separated and further decomposed. The system is shown in FIG. 3.

In the polluted water clarification system so constructed as described above, the polluted water is pulled at a predetermined position in a clarifying tank 11, and a solution containing hypochlorous acid and an acid are added thereto. The gas is started to recycle in a closed loop of a circulation passageway 10 for aeration of the hypochlorous acid solution polluted water containing polluted water. The decomposition objects and chlorine in the hypochlorous acid solution are then diffused into a gas phase, discharged and irradiated with a lamp as a light irradiation device 6, thereby sequentially decomposing and separating the decomposition objects dissolved in polluted water.

The separation vessel is placed in the closed loop of the aeration circulation passageway 10, the pump 2 is placed at the upstream of the separation vessel 1 placed in the closed loop of the aeration circulation passage way 10, and the hypochlorous acid solution containing polluted water in the clarifying tank 11 is aerated at the downstream, thereby pressurizing the inside of the separation vessel 1. As a result, the decomposition products are trapped in the separation vessel 1.

Most of the degradation products are converted into inorganic substances by flowing a current through decomposition electrodes 4a and 4b in the separation vessel.

Decomposition of retrieved solvents was experimentally confirmed using the apparatus shown in FIG. 3.

Desorbed water from activated charcoal was used as the decomposition object. Decomposition objects of polluted gases extracted by a vacuum extraction method from the polluted soil comprising organic chlorine compounds are adsorbed on the activated charcoal. The pollutants were desorbed by steam distillation, and found that 50 mg/L of trichloroethylene, 40 mg/L of dichloromethane, 120 mg/L of trichloroethylene, 20 mg/L of 1,1,1-trichloroethane and 70 mg/L of cis-1,2-dichloroethylene were contained in desorbed water.

Twenty liter of desorbed water was introduced into the clarifying tank with a net volume of 50 L. Further added were 12 mL of a 12% sodium hypochlorite solution (Kishida Chemical Co., 12% immediately after production with a minimum quantity of effective chlorine of 5%) and 6 mL of hydrochloric acid (35%). Polluted desorbed water showed a pH value of 2.5 and residual chlorine concentration in the range of 70 to 90 mg/L.

Polluted water was the aerated by operating the pump 2 (Iwaki APN215). The air in the circulation passageway 10 is blown into the clarifying tank 11 through an aeration port 12, and returns to the pump through the piping 9 for recycling. The flow rate was 15 L/min.

A light was irradiated to treatment water and gas phase through a glass face from the both sides of the clarifying tank 11. Ten units each of the black light fluorescence lamps 6 (10 W lamp, trade name FL10BLB made by Toshiba Corporation) were disposed at both sides of the tank.

Platinum plate electrodes were used for electrolysis in the separation vessel 1 at a voltage of 14V with a current of 1 A. The separation vessel 1 with a volume of 500 ml is previously filled with 200 ml of 0.1% aqueous sodium chloride solution.

After 1 hour's operation, the contents of trichloroethylene, dichloromethane, tetrachloroethylene 1,1,1-ttichloroethane and cis-1,2-dichloroethtlene were measured by EDC gas chromatography. The concentrations of the decomposition objects were also measured in the gas phase.

The results showed that trichloroethylene, dichloromethane, tetrachloroethylene 1,1,1-ttichloroethane were decomposed to the concentrations of 0.03 mg/L or less.

The concentration of the decomposition products were measured after the desorbed water clarification operation of 15 cycles of recycling, and it was found that 95% or more of the decomposition products trapped in the separation vessel 1, which is determined by calculation, were decomposed and converted into inorganic substances by the electrodes in the separation vessel 1.

### Example 3

Although the light source with a wavelength range of 300 nm to 500 nm was used in Example 1 as the light irradiation device, a light source having a peak at 254 nm (for example a sterilization lamp) was used in this example. A light irradiation unit having the sterilization lamp inserted into a quartz tube was placed in the photolysis reaction tank 5 in place of the black light. The experiment was carried out by the same method as in Example 1, except that 200 ppmv of tetrachloroethylene was introduced from the piping 7. It was confirmed that trichloroacetic acid as a decomposition product was separated in the separation vessel, and trichloroacetic acid was further decomposed by electrolysis at the electrodes in the separation vessel.

### Example 4

(Polluted Gas Clarification System)

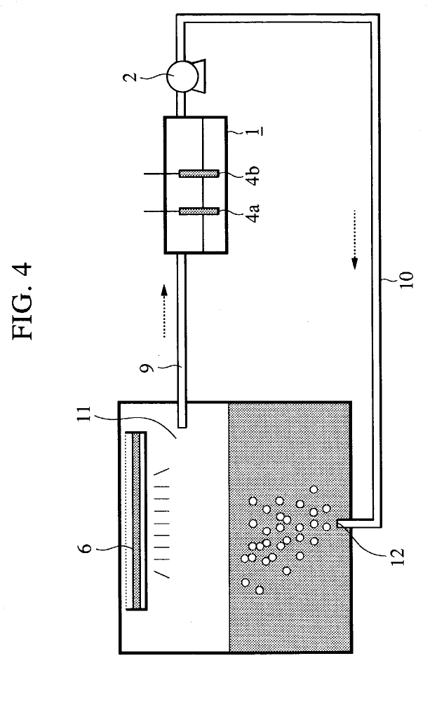

FIG. 4 shows a different construction of the present invention. Different from Example 1, a solution containing hypochlorous acid is used in this system. A gas containing chlorine is generated by introducing the gas into the solution containing hypochlorous acid. The pH of the solution is adjusted to a predetermined value by adding an acid into the solution containing hypochlorous acid, in order to more effectively generate chlorine. The scheme is similar to Example 1, except allowing chlorine to be generated.

The solution containing hypochlorous acid for generating chlorine is pooled in a chlorine generation tank 16, and air containing chlorine is sent to the photolysis reaction tank 5 through the piping 14 by blowing air from the piping 15. The gas containing the substances as the decomposition objects is sent to the photolysis reaction tank 5 from the piping 13.

Water for the solution containing hypochlorous acid for generating chlorine preferably has a hydrogen ion concentration (pH value) of 1 or more and 4 or less, and a chlorine concentration of 10 mg/L or more and 1500 mg/L or less. More preferably, the hydrogen ion concentration (pH value) is in the range of 1 or more and 3 or less.

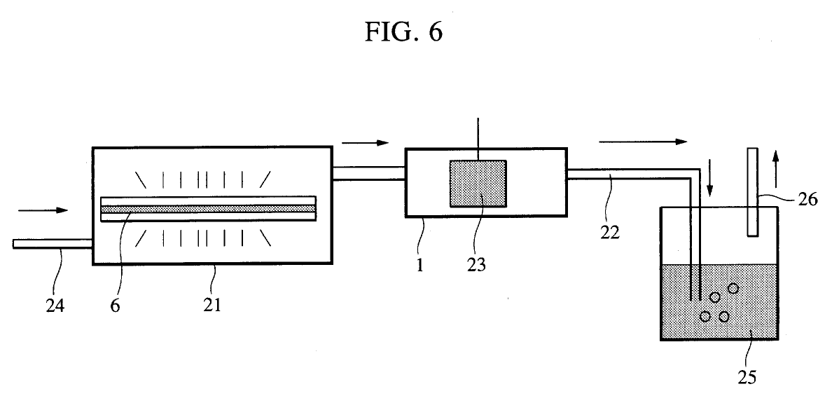

For obtaining such solution (functional water), an electrolyte is dissolved in original water, and this aqueous electrolyte solution is subjected to electrolysis, for example, in a chlorine generation tank 16 comprising a pair of electrodes 20 and 21 partitioned by a pair of ion exchange membranes 19 as shown in FIG. 6. Functional water is obtained in the vicinity of the positive electrode 20. Sodium chloride or potassium chloride is preferably used as the electrolyte. Air containing chlorine is sent into the photolysis reaction tank 5 through the piping 14 by blowing air into generated functional water from the piping 15.

The system was operated by the similar method as in Example 1, except that the chlorine feed device was changed. Separation ability of the separation vessel and decomposition ability of the electrodes after the separation were not different from the results in Example 1, even by changing the chlorine source.

It was revealed that the present invention is applicable irrespective of the device and method for generating chlorine.

### Example 5

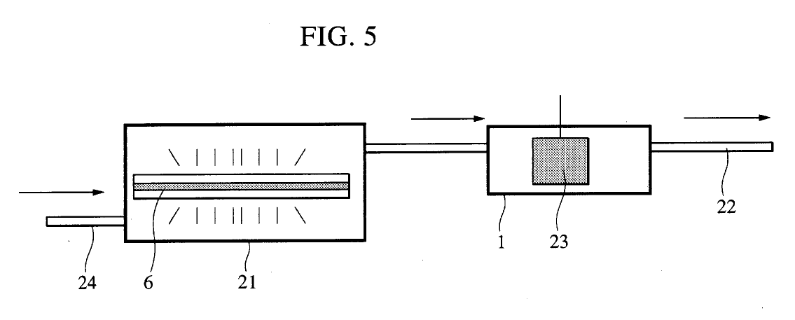

A solution adjusted to a hydrogen ion concentration (pH value) of 3 using hydrochloric acid was previously filled in the separation vessel 1 using the polluted water clarification system shown in FIG. 5. The experiments were carried out by the similar method as in Example 2 except electrolysis.

The results showed that the decomposition products and chlorine were separated in the separation vessel 1, and chlorine is able to be used again in the clarifying tank 11 by recycling through the circulation passageway 10.

It was also show that polluted water is clarified and the decomposition products are retrieved in the separation vessel.

According to the present invention, the products generated by decomposition is able to be separated from the substances to be decomposed.

The present invention is applicable to both polluted gas and polluted water.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for separating each substance from a mixed gas containing a plurality of substances comprising the steps of:
liquefying the mixed gas by cooling; and
separating the plural substances transferred into a liquid generated by the liquefying step into the substances of one group and the substances of the other group,
wherein the substances of one group substantially remain to present in the liquid and the substances of the other group are separated from the liquid by evaporation.

2. A method according to claim 1,
wherein the substances of the other group are evaporated by changing the property of the liquid.

3. A method according to claim 1,
wherein the mixed gas comprises at least acidic substances and chlorine.

4. A method according to claim 3,
wherein the liquid generated by evaporation is an acidic solution.

5. A method according to claim 4,
wherein the hydrogen ion concentration (pH) of the acidic solution is 4 or less.

6. A method according to claim 4,
wherein the acidic substances remain to present in the acidic solution, and the acidic substances and chlorine are separated with each other by evaporating chlorine from the liquid.

7. A method according to claim 6, further comprising the step of allowing evaporated chlorine to contact an alkaline solution.

8. A method according to claim 1,
wherein the mixed gas contains decomposition products generated by decomposition by irradiating a light to decomposition objects.

9. A method according to claim 8,
wherein the decomposition objects comprise organic chlorine compounds.

10. A method according to claim 9,
wherein the light is irradiated in the presence of chlorine.

11. A method according to claim 1, further comprising the step of subjecting the liquid generated in the liquefying step to electrolysis.

12. A method according to claim 8,
wherein the gas containing the substances of the other group are used for decomposition again.

13. An apparatus for separating each substance from a mixed gas containing a plurality of substances comprising:
cooling means for liquefying the mixed gas by cooling; and
separation means for separating the plural substances transferred into a liquid generated by the liquefying means into the substances of one group and the substances of the other group,
wherein the substances of one group substantially remain to present in the liquid and the substances of the other group are separated from the liquid by evaporation.

14. A method according to claim 13, further comprising means for electrolysis of the liquid generated in the liquefying step.
